(19) United States
(12) Patent Application Publication
(10) Pub. No.: US 2024/0322584 A1
(43) Pub. Date: Sep. 26, 2024

(54) PORTABLE POWER SUPPLY SYSTEM COMPRISING AN AC-TO-DC CONVERTER

(71) Applicant: Eudokia Designs LLC, Salado, TX (US)

(72) Inventor: Brian D. ALEXANDER, Douglas, MI (US)

(21) Appl. No.: 18/610,049

(22) Filed: Mar. 19, 2024

Related U.S. Application Data
(60) Provisional application No. 63/491,911, filed on Mar. 23, 2023.

(51) Int. Cl. H02J 7/00; H02J 7/04

(52) U.S. Cl. CPC H02J 7/0068; H02J 7/04; H02J 2207/20; H02J 2310/22

(57) ABSTRACT

A portable power supply system comprises a housing that supports a battery charging circuit that is operatively connected to the AC-to-DC converter, and a battery, supported by the housing, is operatively connected to the battery charging circuit. One or more power outlets are supported by the housing, where each of the power outlets comprises only DC power output. A power source switching circuit is supported by the housing and operatively connected to the AC-to-DC converter, the battery and the power outlets. The power source switching circuit is configured to provide power from the AC-to-DC converter to the power outlets when an input to the AC-to-DC converter is energized, and to provide power from the battery to the power outlets when the input to the AC-to-DC converter is de-energized.

### FIELD

The present disclosure relates generally to power supply systems and, in particular, to a portable power supply system comprising an AC-to-DC converter.

### BACKGROUND

Portable electronic devices are ubiquitous in today's world. Correspondingly, a wide variety of power supply systems (often proprietary) are available to keep such portable devices adequately supplied with the energy needed to ensure their continued operation. Typical examples of such power supply systems are illustrated with regard to FIGS. 1 and 2.

FIG. 1 illustrates a typical scenario in which an electronic device 102 is supplied with power by an alternating current (AC) adapter 104. In particular, the AC adapter 104 typically comprises a male plug 106 capable of being plugged into a corresponding female receptacle 108 that supplies AC power from an AC supply 110. For example, the AC supply 110 may comprise a typical household or utility power supply, which in the United States is typically 120 V or 240 V, 60 Hz AC, though various voltage levels and frequencies may be equally employed. The received AC power is then typically conveyed through appropriate wiring (often, one to several feet in length) to an AC-to-DC converter 112 that comprises circuitry configured to convert the AC voltage into direct current (DC) power suitable for powering the device 102. As shown, the DC output of the AC-to-DC converter 112 is routed, via appropriate wiring, to a suitable connector 114 configured to mate with a corresponding input connector 116 deployed by the electronic device 102.

Generally, the AC-to-DC converter 112 comprises a transformer 120, such as a step-down transformer, suitable for converting the higher voltage AC power to a lower voltage more suitable for powering the device 102. The AC output of the transformer 120 is applied to a rectifier 122 that, as known in the art, converts the AC input (i.e., halfwaves of positive and negative polarity) to a varying DC output (i.e., a single positive or negative polarity). For example, the rectifier 122 may comprise a full-wave diode bridge circuit as known in the art, though it is appreciated that various types of rectifiers circuits could be equally employed. The DC output of the rectifier 122 is provided to known conditioning circuitry 124 to provide a consistent DC output voltage. For example, the conditioning circuitry 124 may comprise one or more filters, such as a capacitor, that are applied to the varying DC voltage to perform initial smoothing thereon. The conditioning circuitry 124 may further comprise a DC voltage regulator that receives the filtered DC waveform and provides a consistent DC output at the desired voltage, e.g., 5-24 VDC.

The electronic device 102, which may comprise, for example, a laptop computer, mobile phone, etc., often includes circuitry that allows the device 102 to be operated by either power provided the AC adapter 104 or from an internal battery 138. In particular, the device 102 may include one or more DC-to-DC converters 130 capable of converting the DC signal applied to its input connector 116 into other DC signals having voltages necessary for specific operations. For example, the DC-to-DC converters 130 may comprise a first converter for stepping down the received DC voltage to one or more levels suitable for power digital logic devices or the like, e.g., 5 V, whereas a second converter may be provided for stepping up the received DC voltage to a level suitable for powering battery charging circuitry 136. Furthermore, when the battery 138 is used to power the internal loads 134 of the device 102, a converter 130 may be provided to change the DC output of the battery 138 to a level suitable for the internal loads 134. It is appreciated that the number and type of DC-to-DC converters 130 employed may vary depending on the nature of the device 102, including the possibility of allowing the received DC voltage to be used without further conversion.

The battery charging circuit 136 operates to control charging of the battery 138 and application of power to the internal loads 134 whenever a DC input is provided to the device 102, i.e., when the device power input 116 is energized. Additionally, when the device power input 116 is energized, the battery charging circuit 136 (or a power switching circuit deployed separately; not shown) operates, based on the DC input received thereby, to charge the battery 138 as needed. On the other hand, when no DC input is provided to the device 102, i.e., when the device power input 116 is not energized, the battery charging circuit 136 operates to detect this condition and to regulate discharge of the battery 138 to power the internal loads 134. That is, the battery charging circuit 136 is capable of determining whether or not the device 102 is receiving power from the AC adapter 104 and, based on this determination, providing operational power to the device either based on the received DC power or from the battery 138.

FIG. 2 illustrates a scenario in which an AC adapter 104, as described above, is used to provide DC power to, in this case, a portable power bank 202. The portable power bank 202 differs from the electronic device 102 of FIG. 1 in that it is generally used solely for the purpose of storing electrical power for later output to electronic devices, including but not limited to, for example, devices 102 similar to that shown in FIG. 1.

In this case, the power bank 202 may comprise a battery charging circuit 242 and battery 244. An optional DC-to-DC converter 240 may be provided if the input DC voltage from the AC adapter 104 does not meet the requirements of the battery charging circuit 244. When the input 116 of the power bank is energized by the AC adapter 104, the battery charging circuit 242 operates to charge (or maintain the charge in) the battery 244. Unlike the device 102, however, the power bank 202 may include power outputs in the form of an AC outlet 248 and one or more DC power ports 254, all operatively connected to the battery 244. More specifically, the AC outlet 248 is operatively connected to a DC-to-AC converter 246 (often referred to as an inverter) that converts the DC power signal provided by the battery 244 to a suitable AC power signal 250. Similarly, the DC port(s) 254, such as one or more USB ports as known in the art, are operatively connected to a DC-to-DC converter 252 used to convert the DC power signal provided by the battery 244 to a DC power signal 256 having a suitable voltage level to be output via the DC port(s) 254.

While the systems illustrated in FIGS. 1 and 2 provide acceptable performance, further improvements are possible. For example, the ability of AC adapters 104 to provide power is necessarily dependent upon being connected to an AC supply 110. That is, if the AC adapter 104 is not “plugged in” to the AC supply 110, it is incapable of providing the desired DC output. Consequently, when an AC adapter 104 transitions from a “plugged in” to an “unplugged” state, as in the case, for example, where a user is moving around in an environment and may need to access various AC supply sources such as wall outlets, any device powered by the AC adapter 104 may experience a power interruption until such time that the AC adapter 104 is once again “plugged in.” Additionally, to the extent that AC adapters 104 are often proprietary and designed to operate with a limited set of device, it sometimes becomes necessary to have multiple different AC adapters available for use with multiple, but otherwise power-input incompatible, devices.

Thus, power supply systems that improve upon the current state of the art would be a welcome development.

### SUMMARY

The instant disclosure describes a portable power supply system comprising a housing and an AC-to-DC converter supported by the housing. A battery charging circuit is supported by the housing and operatively connected to the AC-to-DC converter, and a battery is supported by the housing and operatively connected to the battery charging circuit. One or more power outlets are supported by the housing, where each of the power outlets comprises only DC power output. A power source switching circuit is supported by the housing and operatively connected to the AC-to-DC converter, the battery and the power outlets. The power source switching circuit is configured to provide power from the AC-to-DC converter to the power outlets when an input to the AC-to-DC converter is energized, and to provide power from the battery to the power outlets when the input to the AC-to-DC converter is de-energized. In an embodiment, the battery charging circuit is configured to charge or maintain charge of the battery when the input to the AC-to-DC converter is energized.

In another embodiment, the housing is configured to mount on an edge of a planar member. For example, the housing can be U-shaped with a first leg and second leg interconnected by a span dimensioned to permit the planar member to fit between the first and second legs. In the case of the U-shaped housing, the AC-to-DC converter and the battery may be disposed in the first leg and the power outlets may be disposed in the second leg. Further to this embodiment, the AC-to-DC converter and battery may be operatively connected to the power outlets via cabling running from the first leg to the second leg via the span. The housing may be configured such that the first leg extends further away from the span than the second leg.

In another embodiment, the power outlets are disposed on an outward facing surface of the housing.

The portable power supply may also include an attachment mechanism supported by the housing and configured to retain the housing in mounted engagement with the planar surface. For example, the attachment mechanism may comprise a clamp or a spring.

The portable power supply may further comprise a battery charge indicator operatively connected to the battery charging circuit as well as a power source indicator operatively connected to the power source switching circuit.

In an embodiment, the power outlets may comprise at least one USB-compatible connector. Additionally, the portable power supply may comprise a USB analysis circuit operatively connected to the at least one USB-compatible connector and at least one status indicator operatively connected to the USB analysis circuit and uniquely corresponding to the at least one USB-compatible connector.

### BRIEF DESCRIPTION OF THE DRAWINGS

The foregoing and other features and advantages will be discussed in detail in the following non-limiting description of specific embodiments in connection with the accompanying drawings, in which:

FIGS. 1 and 2 are schematic block diagrams illustrating power supply systems in accordance with prior art techniques;

FIG. 3 is a schematic block diagram of a portable power supply in accordance with the instant disclosure;

FIG. 3A is a schematic block diagram of an alternative embodiment of a portable power supply in accordance with the instant disclosure;

FIG. 4 is a perspective view of an embodiment of a portable power supply in accordance with the instant disclosure;

FIGS. 5 and 6 are perspective views illustrating an embodiment of a housing in accordance with the portable power supply of FIG. 4;

FIG. 7 is a side elevational view illustrating the embodiment of the housing in accordance with the portable power supply of FIG. 4;

FIG. 8 is a side elevational view of the embodiment illustrated in FIG. 4 showing use of the attachment mechanism in conjunction with a planar surface;

FIG. 9 is a side elevational view of the embodiment illustrated in FIG. 4 and illustrating an alternative embodiment of an attachment mechanism; and

FIG. 10 is side perspective view of a portable power supply, without the housing, in accordance with the instant disclosure.

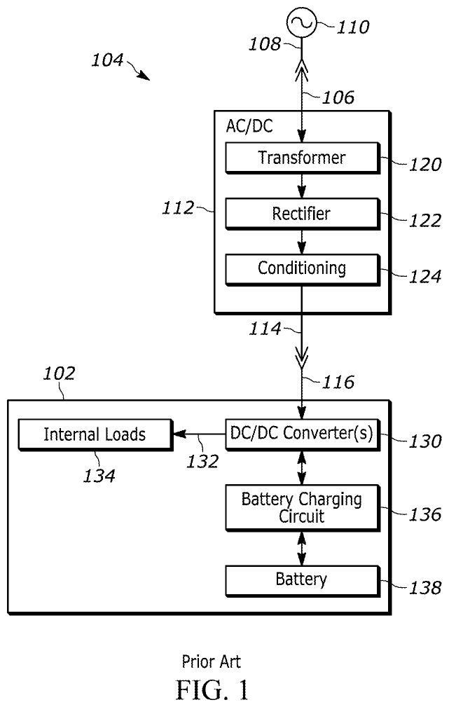

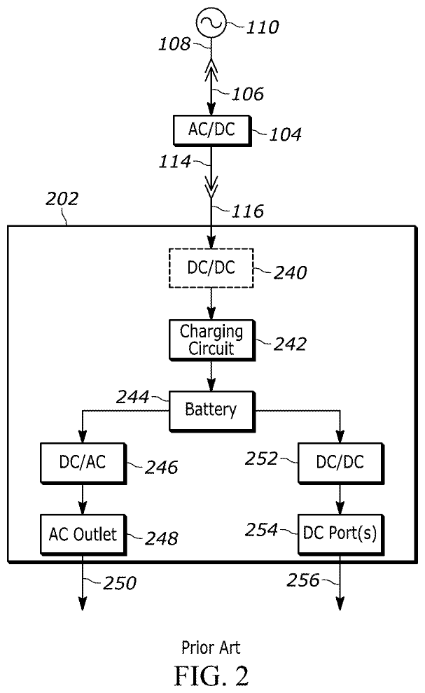

### DETAILED DESCRIPTION OF THE PRESENT EMBODIMENTS

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise.

As used herein, the term “substantially” or similar words requiring subjective comparison are intended to mean “within manufacturing tolerances” unless stated or implied by context otherwise.

As used herein, the phrase “operatively connected” refers to at least a functional relationship between two elements and may encompass configurations in which the two elements are directed connected to each other, i.e., without any intervening elements, or indirectly connected to each other, i.e., with intervening elements.

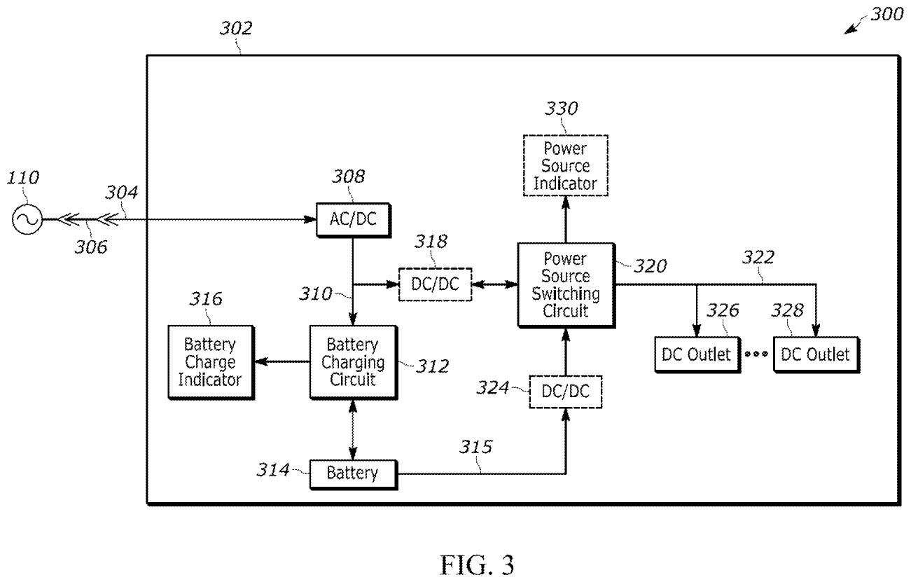

FIG. 3 schematically illustrates a portable power supply system 300 comprising a housing 302 providing support for various components described herein. In an embodiment, the housing 302 is configured to have external dimensions suitable for a user to hold the system 300 in a single hand, thereby making the system 300 readily portable. Additionally, as described in further detail below, the housing 302 may be configured to facilitate ready deployment of the system in typical user environments such as an office, school or home.

In the illustrated embodiment, the housing 302 provides support for an input connector 304 configured to receive AC power from an AC supply 110 via a suitable power cord 306. By way of non-limiting example, the input connector 304 may comprise an appliance inlet and the power cord 306 may comprise a connector used to implement an appliance coupler in compliance with the IEC (International Electrotechnical Commission) 60320 standard. Those skilled in the art will appreciate that other input connectors 304 may be equally employed for this purpose and the instant disclosure is not limited in this regard.

As shown, the input connector 304 is operatively connected, particularly in electrical communication with, an AC-to-DC converter 308. That is, and in accordance with the converter 112 described above, the AC-to-DC converter 308 comprises a transformer, rectifier circuitry and conditioning circuitry suitable for providing a DC power signal 310. For example, the DC power signal 310 may comprise a 5-24 VDC signal. As further shown, the AC-to-DC converter 308 is operatively connected to, particularly in electrical communication with, a battery charging circuit 312. In turn, the battery charging circuit 312 is operatively coupled to, particularly in electrical communication with, a battery 314 and a battery charge indicator 316. The battery charging circuit 312 may comprise a commercially available battery charging circuit as known by those skilled in the art, the exact nature of which will necessarily depend on the type of battery 314. Generally, the battery 314 is selected to provide sustained delivery of a desired level of power (voltage and current) to one or more DC-only power outlets 326, 328 (two shown for illustration purposes only) as described in further detail below.

In an embodiment, a battery charge indicator 316 may be operatively connected to the battery charging circuit 312. The battery charge indicator 316 may comprise a device, as known in the art, capable of converting data or signals provided by the battery charging circuit 312 and indicative of the state of charge of the battery 314 into a user-perceivable indication, e.g., a hierarchically arranged series of light emitting diodes (LEDs) that are successively turned on or off to illustrate, respectively, increased or decreased charge levels of the battery 314.

As further shown, the AC-to-DC converter 308 is also operatively connected to a power source switching circuit 320 that, in turn, is operatively connected to the battery 314 as well as the DC-only power outlets 326, 328, via an output 322, as described in greater detail below. In an embodiment, the power source switching circuit 320 operates to determine whether or not the input connector 304 is energized by the AC supply 110 (based on the presence or absence of the DC power signal 310, for example) and, based on this determination, to switch the output 322 between power supplied by the DC power signal 310 or a battery output voltage 315. For example, in an embodiment, the power source switching circuit 320 may comprise circuitry, as known in the art, used to implement a so-called uninterruptible power supply (UPS), but instead of switching between an AC supply or an inverter output as in the case of a typical UPS, the power source switching circuit 320 switches between the DC power signal 310 and the battery 314, as previously noted.

In order to ensure that the power signal provided at the output 322 of the power source switching circuit 320 is at a desired voltage, optional DC-to-DC converters 318, 324 may be included in the path supplying the DC power signal 310 and/or the battery output voltage 315. The use of such converters 318, 324 will depend on the desired DC voltage to be provided at the power outlets 326, 328 and the voltages provided by the DC power signal 310 and the battery output voltage 315. As a non-limiting example, where the output 322 of the power source switching circuit 320 is required to be 5 V and both the DC power signal 310 and the battery output voltage 315 are in the range from 5-24 V, both converters 318, 324 may comprise buck converters, as known in the art. Additionally, although the converters 318, 324 are illustrated as separate components, it is appreciated that the converters 318, 324 may be provided in a single device, i.e., in a multi-circuit packaging format.

A feature of the instant disclosure is that the power outlets 326, 328 provide only DC outputs as power signals used to power devices connected thereto. For example, in an embodiment, the power outputs 326, 328 may comprise Universal Serial Bus (USB)-compatible connectors, more particularly, female connectors in accordance with the so-called USB-A or USB-C standards. Further this example, the power outlets 326, 328 may comprise multiple female USB-A connectors and one or more female USB-C connectors, thought other combinations are certainly possible and within the scope of the instant disclosure. Indeed, the number of power outlets 326, 328 may be selected as a matter of design choice. As known in the art, USB-compatible connectors are configured only for providing (or receiving) DC power signals. By eliminating any AC power outputs, complexity, size and weight of the portable power supply system 300 is beneficially reduced. While USB-A and USB-C connectors have been set forth herein as examples, those skilled in the art will appreciate that other options, e.g., Apple Lightning or barrel connectors, may be equally employed.

As an option, the power source switching circuit 320 may be operatively connected to a power source indicator 330. In an embodiment, the power source indicator 330 may comprise one or more user-perceptible devices providing indicia to the user as to the state of the power source switching circuit 320. For example, the power source indicator 330 may comprise a red/green bi-colored LED configured to operate such that separate colors uniquely correspond to the two separate operating states of the power source switching circuit 320, e.g., where the red color is used to indicate that the system 300 is being powered by the battery 314 and the green color is used to indicate that the system in being powered by the AC supply 110. Alternatively, the power source indicator 330 may comprise a liquid crystal display (LCD) configured to display alternate symbols (e.g., a cord with a plug, on one hand, or a battery on the other) corresponding to the operating states of the power source switching circuit 320. Still other options will be apparent to those skilled in the art and the instant disclosure is not limited in this regard.

Referring now to FIG. 3A, an alternative embodiment of a portable power supply system 300′ is illustrated. In particular, the system 300′ differs from the system 300 of FIG. 3 in that it further comprises one or more analysis circuits 340 operatively connected to the power outlets 326, 328 and to outlet status indicators 342, 344 uniquely corresponding to the power outlets 326, 328. The analysis circuit 340 may comprise a circuit, in accordance with known techniques, capable of determining operational statuses for any one or more of the power outlets 326, 328. For example, the analysis circuit 340 may operate to measure resistances of the power outlets 326, 328 in order to ascertain the possible existence of short circuit or open circuit conditions. Alternatively, or additionally, the analysis circuit 340 may operate to assess abnormal power conditions such as over- or under-voltages conditions or excessive current draws. The outlet status indicators 342, 344, which may comprise any suitable, user-perceivable indicators (e.g., LEDs, LCD screens, etc.), are operative to provide indicia based on the respective analysis results provided by the analysis circuit 340. For example, where the power outlets 326, 328 are all in good operating condition, a green LED may be illuminated as the outlet status indicator 342, 344 for each power outlet. On the other hand, for a power outlet in which a fault condition is determined, a red LED may be illuminated as the outlet status indicator for that power outlet. As will be appreciated by those skilled in the art, more detailed indicia may be provided through the use of specific flashing patterns of such LEDs. Further still, where the outlet status indicators 342, 344 are implemented as text or image capable screens, suitable text or images may be employed to provide specific status indications, e.g., the word “Good” or a lightning bolt symbol to indicate a normally-functioning power outlet, or “Fault #n” where n is a number of a specific fault code to indicate a specific error condition identified by the analysis circuit 340. Once again, those skilled in the art will appreciate that various other display techniques may be equally employed for this purpose.

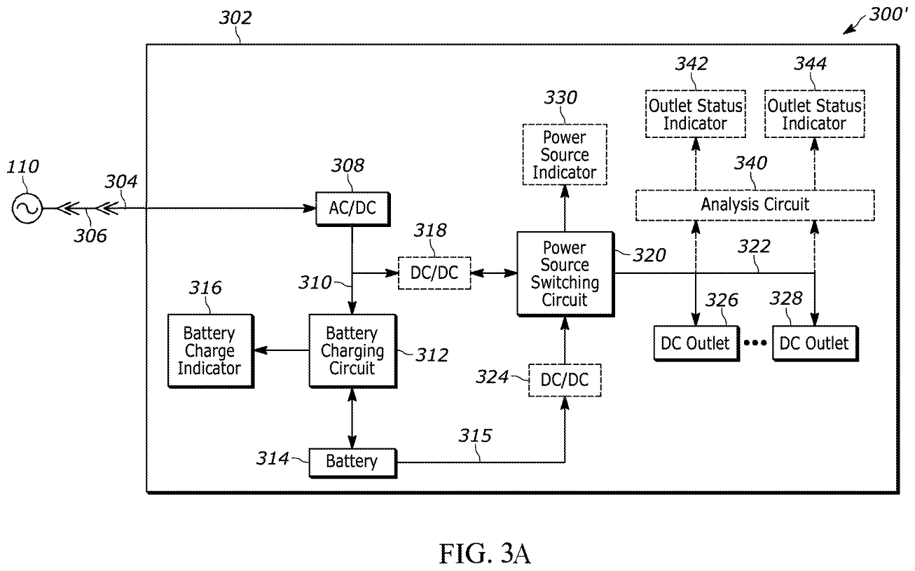

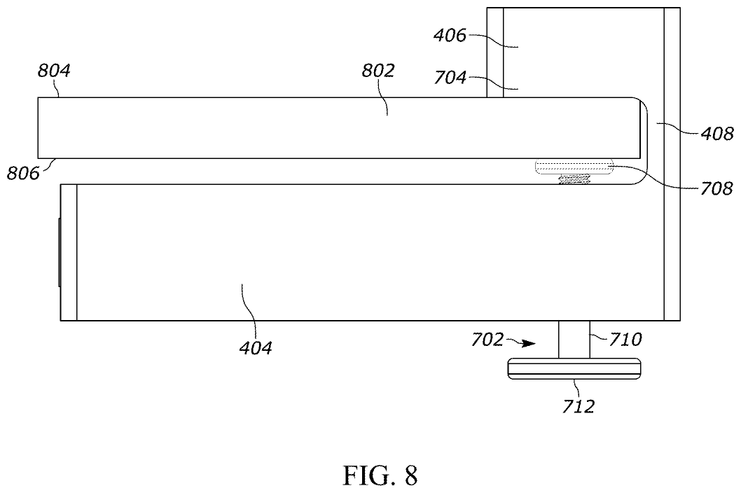

Referring now to FIGS. 4-10 an embodiment of a portable power supply system 400 in accordance with the instant disclosure, and features and variants thereof, is illustrated. As best shown in FIG. 4, the portable power supply system 400 includes a housing 402 formed in a U-shape comprising a first leg 404 and a second leg 406 interconnected by a span 408. The housing 402 may be fabricated using known injection molded plastic techniques, though it is appreciated that other techniques, e.g., steel sheet metal or aluminum (cast, extruded or sheet metal) may also be used. In the illustrated embodiment, the first and second legs 404, 406 are substantially parallel to each other and at 90° angles to the span 408. As further shown, the first leg 404 has a length, i.e., its extent away from the span, that is greater than a length of the second leg 406, though this is not a requirement and it is appreciated that the first and second legs 404, 406 could have substantially equal lengths or the length of the second leg 406 could be greater than the length of the first leg 404. Additionally, respective heights (along the vertical axis as depicted in s FIGs.) of the first and second legs 404, 406 may be equal or different as a matter of design choice. For example, as shown in FIGS. 4, 7 and 9, the height of the first leg 404 is greater than the height of the second leg 406, whereas, as depicted in FIG. 8, the height of the first and second legs 404, 406 is substantially equal.

Referring again to FIG. 4, a battery charge indicator 412 and power outlets 414, 416, as described above, are disposed on an outward surface 406a of the housing 402, specifically an upper surface of the second leg 406. It is appreciated that various ones of the battery charge indicator 412 and power outlets 414, 416 (or any other user-perceivable or user-accessible components) could be equally deployed on other surfaces of the housing, e.g., the vertical, lateral or end surfaces of the first or second legs 404, 406 as depicted in FIG. 4. Further still, an input connector 410 (for connection to a suitable cord, for example, to an AC supply) may be deployed on a vertical, end surface of the first leg 404 as shown in FIG. 4, though it is once again appreciated that the input connector 410 may be deployed on any reasonably accessible surface of the housing 402.

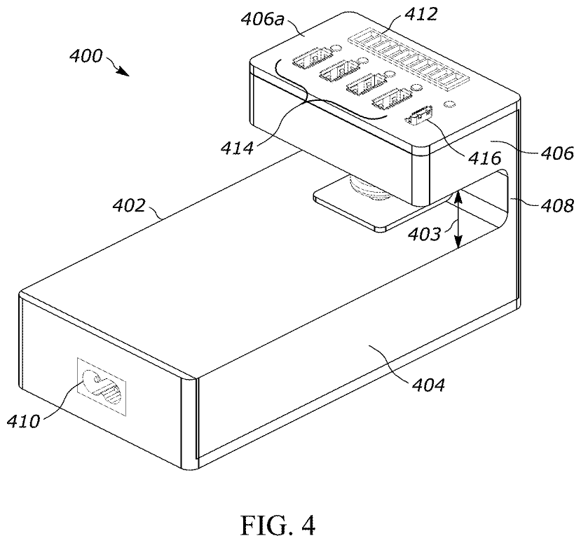

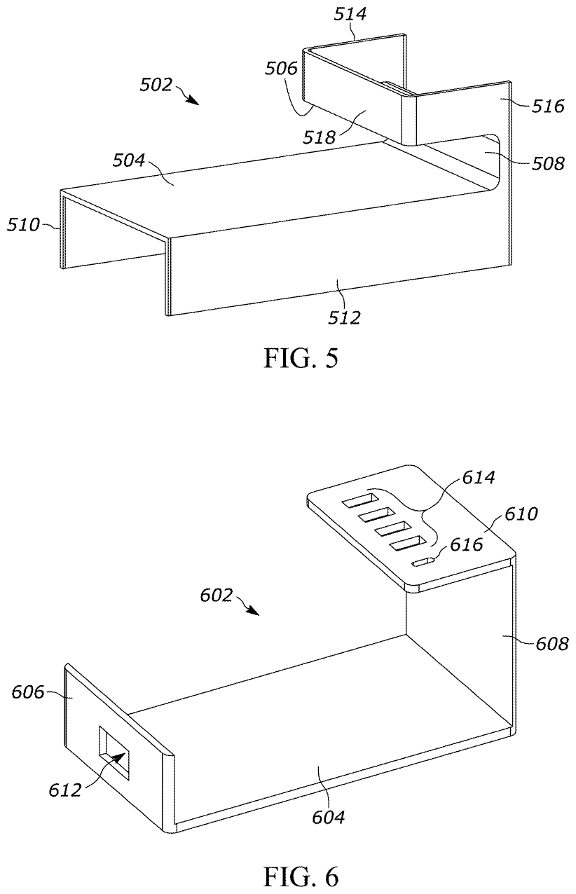

In an embodiment, the housing 402 is formed of multiple parts that may be joined together to provide the unitary body of the housing 402. An example of this is illustrated in FIGS. 5 and 6 in which the housing 402 comprises an upper housing portion 502 and a lower housing portion 602. As shown, the upper housing portion 502 includes substantially planar walls forming inner-facing surfaces 504, 506, 508 of the first arm 404, second arm 406 and span 408, respectively. Additional planar walls 510, 512, 514, 516 are provided to form vertical, lateral surfaces of the first and second arms 404, 406 respectively, and a further planar wall 518 is provided to form the vertical, end surface of the second arm 406, as shown. In turn, the lower housing portion 602 comprises a lower wall 604 forming a base of the housing 402 and two walls 606, 608 vertically extending at substantially 90° angles from the lower wall 604, thereby forming end walls of the first and second legs 404, 406 and the span 408. A top wall 610 extends laterally away from the second end wall 608 and substantially parallel to the lower wall 604, thereby forming an upper wall of the second leg 404. As further shown in FIG. 6, the first end wall 606 has an opening 612 formed therein to receive the input connector 410, whereas the top wall 610 comprises openings 614, 616 to receive respective ones of the output connectors 414, 416. Though specific openings 614, 616 and configurations thereof are illustrated in FIG. 6, it is appreciated that any number of desired openings in any desired configuration may be provided as a matter of design choice.

Using known techniques, the upper and lower housings 502, 602 may be permanently or semi-permanently joined together to provide the unitary body of the housing 402. For example, reversible fasteners, e.g., screws, clips or the like, could be employed such that upper and lower housings 502, 602 are rigidly coupled to each other, but readily separable from each other by virtue of the reversible fasteners. Alternatively, in the case where the upper and lower housings 502, 602 are fabricated from suitable polymer materials, thermal welding could be employed to permanently join the upper and lower housing 502, 602 to form the housing 402 illustrated in FIG. 4. It is appreciated that the instant disclosure is not limited in this regard.

While specific configurations of constituent parts of the housing 402 are illustrated in FIGS. 5 and 6, it is appreciated that other configurations, possibly requiring more than two constituent parts, may be provided and that the instant disclosure is not limited in this regard.

Further still, in an embodiment, a space 403 between the first and second legs 404, 406 is configured to be sufficiently large to receive an edge of a planar member 802 as best shown in FIG. 8. Though the planar member 802 illustrated in FIG. 8 is illustrated as being substantially horizontal, it is appreciated that the planar member 802 may be oriented at virtually any angle up to and including substantially vertical. Further still, orientation of the planar member 802 may be at angles such that the force of gravity (or movement or vibrations applied to the planar member 802) may tend to urge the housing 402 to disengage from the planar member 802. In this case, continued engagement of the housing 402 with the planar member 802 may be facilitated through the use of an attachment mechanism.

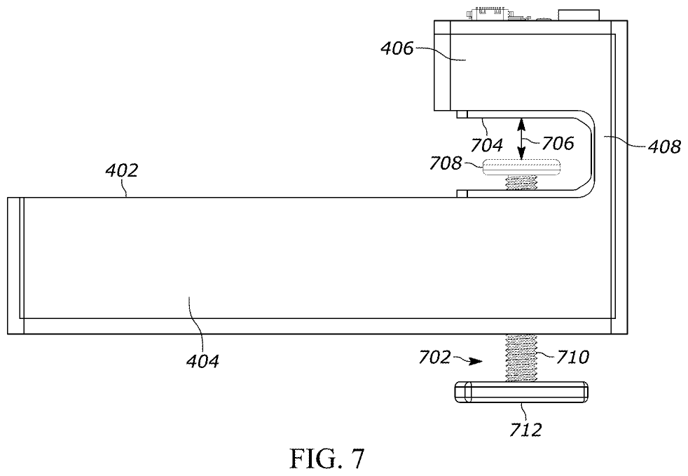

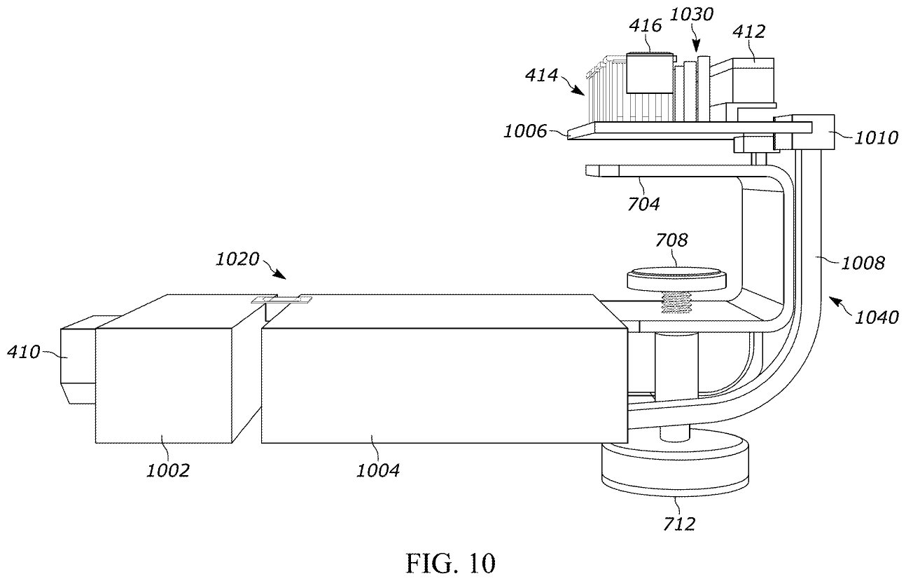

Referring now to FIG. 7, an example of an attachment mechanism 702, supported by the housing 402, is shown. In the illustrated example, the attachment mechanism 702 comprising a clamp that, in turn, comprises a fixed jaw member 704 and an adjustable jaw member 708 disposed on an end of a threaded spindle 710. In an embodiment, the adjustable jaw member 708 is maintained in a substantially perpendicular orientation relative to a longitudinal axis of the spindle 710 while also able rotate freely about the longitudinal axis. A handle 712 is affixed to the spindle at an opposite end thereof such that rotation of the handle 712 induces rotation of the spindle 710. As best shown in FIG. 10, the spindle 710 may be threadedly engaged with a correspondingly threaded portion of the fixed jaw member 704. In this manner, rotation of the handle 712 may urge the adjustable jaw member 704 upward or downward (as depicted in the FIGs.). In an embodiment a space 706 between fixed and adjustable jaw members 704, 708 may be provided such that an edge of planar member 802 may be accepted therein, as shown in FIG. 8. As further shown in FIG. 8, adjustment of the handle 712 and adjustable jaw member 708 to progressively decrease the space 706 causes the fixed jaw member 704 and the adjustable jaw member 708 to engage with upper and lower surfaces 804, 806, respectively, of the planar member 802. By causing the adjustable jaw member 708 to firmly engage, in this case, with the lower surface 806 of the planar member 802 (i.e., to cause appreciable frictional contact therebetween), the housing may be rigidly, but removably, retained in position relative to the planar member 802.

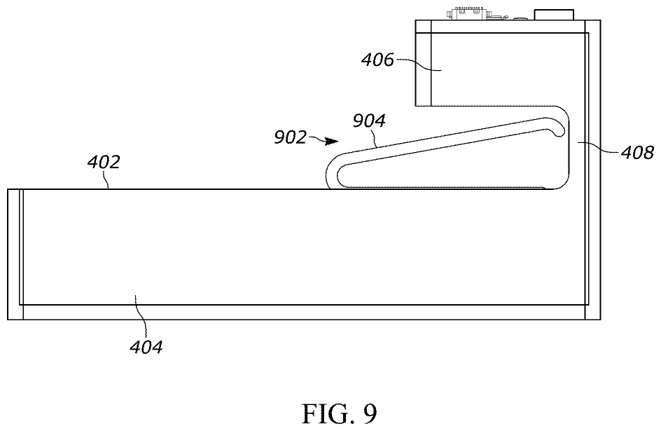

An alternative attachment mechanism 902 is illustrated in FIG. 9. In this embodiment, the attachment mechanism 902 comprises a leaf spring 904 mounted on the first leg 404 of the housing 402, with a free end of the leaf spring 904 disposed within the space 403 between the first and second legs 404, 406. When an edge of a planar member (as described above) is urged into the space 403, and presuming sufficient thickness of the planar member, contact between the planar member and the spring 904 will cause the spring 904 to deflect (downward, as depicted in FIG. 9), thereby placing the spring 904 under compression and applying a frictional biasing force to both the housing 402 and the planar member. Once again, this frictional biasing force will, if sufficiently large, tend to retain the housing 402 engaged with the edge of the planar member while still permitting ready removal of the housing 402 from the planar member as desired.

Referring now to FIG. 10, the embodiment of FIGS. 4 and 7 is illustrated, but without showing the housing 402 such that positioning of the internal components supported by the housing 402 is better illustrated. In particular, an AC-to-DC converter 1002 and a battery 1004 (as described above) are schematically illustrated as being disposed within a region 1020 that would normally be enclosed by the first leg 404. Similarly, a circuit board 1006, supporting the various above-described components 412, 414, 416, is schematically illustrated as being disposed within a region 1030 that would normally be enclosed by the second leg 406. Furthermore, cabling 1008 and suitable circuit board connectors 1010, between the battery 1004 (and other circuitry depicted in FIG. 3 but not explicitly shown in FIG. 10) and the circuit board 1006 (and, therefore the various outlets 414, 416 and battery charge indicator 412) is schematically illustrated as being disposed within a region 1040 that would normally be enclosed by the span 408.

While the various embodiments in accordance with the instant disclosure have been described in conjunction with specific implementations thereof, it is evident that many alternatives, modifications and variations will be apparent to those skilled in the art. For example, as depicted, FIG. 3 shows a separate path from the battery 314 to the power source switching circuit 320. However, it is understood that, in some instances, it may be desirable to instead route battery power to the power source switching circuit 320 via the battery charging circuit 312. In this case, then, one of more of the optional converters 318, 324 may be incorporated into the battery charging circuit 312 or some other component, rather than the power source switching circuit 320. Accordingly, the preferred embodiments of the invention as set forth herein are intended to be illustrative only and not limiting so long as the variations thereof come within the scope of the appended claims and their equivalents.

What is claimed is:

1. Portable power supply system, comprising:
a housing;
an AC-to-DC converter supported by the housing;
a battery charging circuit supported by the housing and operatively connected to the AC-to-DC converter;
a battery supported by the housing and operatively connected to the battery charging circuit;
one or more power outlets supported by the housing and comprising only DC power outputs; and
a power source switching circuit supported by the housing and operatively connected to the AC-to-DC converter, the battery and the power outlets, the power source switching circuit configured to provide power from the AC-to-DC converter to the power outlets when an input to the AC-to-DC converter is energized, and to provide power from the battery to the power outlets when the input to the AC-to-DC converter is de-energized.

2. The portable power supply system of claim 1, wherein the battery charging circuit is configured to charge or maintain charge of the battery when the input to the AC-to-DC converter is energized.

3. The portable power supply of claim 1, wherein the housing is configured to mount on an edge of a planar member.

4. The portable power supply of claim 3, wherein the housing is U-shaped with a first leg and second leg interconnected by a span dimensioned to permit the planar member to fit between the first and second legs.

5. The portable power supply of claim 4, wherein the AC-to-DC converter and the battery are disposed in the first leg.

6. The portable power supply of claim 5, wherein the power outlets are disposed in the second leg.

7. The portable power supply of claim 6, wherein the AC-to-DC converter and battery are operatively connected to the power outlets via cabling running from the first leg to the second leg via the span.

8. The portable power supply of claim 4, wherein the power outlets are disposed on an outward facing surface of the housing.

9. The portable power supply of claim 4, further comprising:
an attachment mechanism supported by the housing and configured to retain the housing in mounted engagement with the planar surface.

10. The portable power supply of claim 9, wherein the attachment mechanism is a clamp.

11. The portable power supply of claim 9, wherein the attachment mechanism is a spring.

12. The portable power supply of claim 4, wherein the first leg extends further away from the span than the second leg.

13. The portable power supply of claim 1, further comprising:
a battery charge indicator operatively connected to the battery charging circuit.

14. The portable power supply of claim of claim 1, further comprising:
a power source indicator operatively connected to the power source switching circuit.

15. The portable power supply of claim 1, wherein the plurality of power outputs comprise at least one USB-compatible connector.

16. The portable power supply of claim 15, further comprising:
a USB analysis circuit operatively connected to the at least one USB-compatible connector; and
at least one status indicator operatively connected to the USB analysis circuit and uniquely corresponding to the at least one USB-compatible connector.
